(19) United States
(12) Patent Application Publication
(10) Pub. No.: US 2003/0147985 A1
(43) Pub. Date: Aug. 7, 2003

(54) Apparatus for feeding reclaimed plastic to injection molding machine

(76) Inventor: Duck-Ho Kim, Seoul (KR)

Correspondence Address: Jay S. CINAMON, ABELMAN, FRAYNE & SCHWAB, 150 East 42nd Street, New York, NY, 10017, US

(21) Appl. No.: 10/354,738

(22) Filed: Jan. 30, 2003

(30) Foreign Application Priority Data
Feb. 7, 2002 (KR) 2002-7046

(51) Int. Cl. B29C 45/18

(52) U.S. Cl. 425/215

(57) ABSTRACT

An apparatus for feeding reclaimed plastic to an injection molding machine is disclosed. The apparatus for feeding reclaimed plastic to an injection molding machine, comprising a heating unit having both a plastic intake port to supply plastic articles to be reclaimed to the heating unit, and a melting furnace to heat and melt the plastic articles at a predetermined temperature to prepare soft reclaimed plastic, further comprising; a first feeding unit receiving the soft reclaimed plastic fed from the melting furnace of the heating unit; and a second feeding unit temporarily storing therein the soft reclaimed plastic fed from the first feeding unit, and controllably feeding the soft reclaimed plastic to the injection molding machine in accordance with a predetermined quantity of soft reclaimed plastic required by said molding machine.

### BACKGROUND OF THE INVENTION

1. Field of the Invention

The present invention relates, in general, to apparatuses for feeding reclaimed plastic to injection molding machines and, more particularly, to an apparatus for feeding soft reclaimed plastic to an injection molding machine while temporarily storing the soft reclaimed plastic and maintaining a temperature of the soft reclaimed plastic at an appropriate point, thus accomplishing smooth and steady feeding of a predetermined quantity of soft reclaimed plastic to the injection molding machine and effectively producing large-sized products using the reclaimed plastic through an injection molding process.

2. Description of the Prior Art

As well known to those skilled in the art, waste plastic articles are classified into reclaimable articles and not-reclaimable articles. The reclaimable waste plastic articles may be regenerated into products of which the grades are the same as those of original articles or products having grades lower than those of the original articles while regarding the protection of environment and the saving of resources.

In order to produce products using such reclaimable waste plastic articles, it is necessary to heat and melt the waste plastic articles at a temperature higher than a predetermined point, thus preparing soft reclaimed plastic. The soft reclaimed plastic is, thereafter, stored temporarily while being maintained at the soft state, and is fed to an injection molding machine wherein the soft reclaimed plastic is molded into a desired product by using a mold. Therefore, the soft reclaimed plastic after being melted must be maintained at the soft state until the plastic is injected to the mold of the injection molding machine.

However, in conventional apparatuses for feeding reclaimed plastic to injection molding machines, soft reclaimed plastic is cooled just after the plastic is fed into a hopper of the plastic feeding apparatus, so that it is almost impossible to continuously melt and mix the reclaimed plastic and fillers. Therefore, an injection molding process of producing products using such reclaimed plastic cannot be not smoothly performed.

When it is desired to produce large-sized plastic products using a large quantity of reclaimed plastic through an injection molding process, the reclaimed plastic must be quickly fed to an injection molding machine just after being melted. Therefore, the hopper of the conventional plastic feeding apparatus is designed such that it has a sealed structure and forcibly pushes soft reclaimed plastic to the injection molding machine in a direction, without allowing the soft reclaimed plastic to stay temporarily after being melted. However, the hopper having the sealed structure cannot smoothly feed the soft reclaimed plastic. In addition, when soft reclaimed plastic is fed to the injection molding machine just after being melted without staying temporarily, as described above, there is no method of solving the problem of generation of gas and moisture from the reclaimed plastic caused by an addition of impurities and another plastic to the soft reclaimed plastic.

That is, the conventional plastic feeding apparatus having the above-mentioned sealed structure cannot smoothly eliminate gas and moisture generated by an addition of impurities and another plastic to the soft reclaimed plastic, so that the conventional plastic feeding apparatus causes big problems in the production process of large-sized products using the reclaimed plastic through an injection molding process.

### SUMMARY OF THE INVENTION

Accordingly, the present invention has been made keeping in mind the above problems occurring in the prior art, and an object of the present invention is to provide an apparatus for feeding reclaimed plastic to an injection molding machine, which is designed such that a desired quantity of soft reclaimed plastic required to produce a large-sized plastic product by the injection molding machine is intermittently supplied to a hopper of the apparatus while maintaining a soft state thereof, which naturally expels gas and moisture generated from the soft reclaimed plastic, thus feeding the soft reclaimed plastic under a desired state, and which feeds a precise quantity of soft reclaimed plastic to the injection molding machine, thus improving productivity and quality of plastic products.

In order to accomplish the above objects, the present invention provides an apparatus for feeding reclaimed plastic to an injection molding machine, comprising a heating unit having both a plastic intake port to supply plastic articles to be reclaimed to the heating unit, and a melting furnace to heat and melt the plastic articles at a predetermined temperature to prepare soft reclaimed plastic, further comprising: a first feeding unit receiving the soft reclaimed plastic fed from the melting furnace of the heating unit; and a second feeding unit temporarily storing therein the soft reclaimed plastic fed from the first feeding unit, and controllably feeding the soft reclaimed plastic to the injection molding machine in accordance with a predetermined quantity of soft reclaimed plastic required by the molding machine.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a front view of an apparatus for feeding soft reclaimed plastic to an injection molding machine according to an embodiment of the present invention;

FIG. 2 is a plan view of first and second feeding units used for storing and feeding the soft reclaimed plastic in the plastic feeding apparatus of the present invention;

FIG. 3 is a perspective view of a hopper included in the first feeding unit of the plastic feeding apparatus according to the present invention;

FIG. 4 is a sectional view of the hopper of FIG. 3; and

FIGS. 5 and 6 are sectional views of the plastic feeding apparatus of the present invention, in which FIG. 5 shows a state of storing soft reclaimed plastic, and FIG. 6 shows a state of discharging the soft reclaimed plastic.

### DETAILED DESCRIPTION OF THE INVENTION

Reference should now be made to the drawings, in which the same reference numerals are used throughout the different drawings to designate the same or similar components.

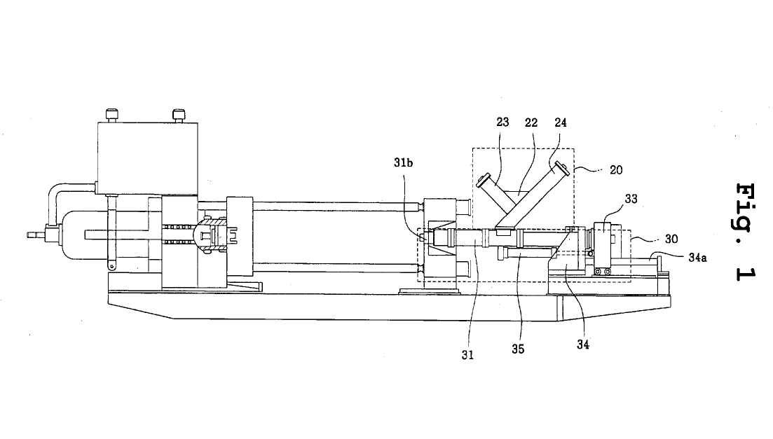

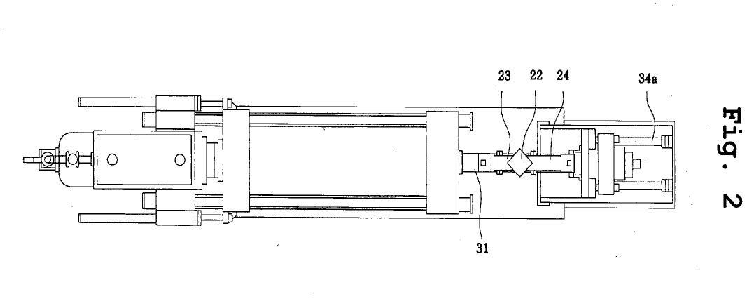

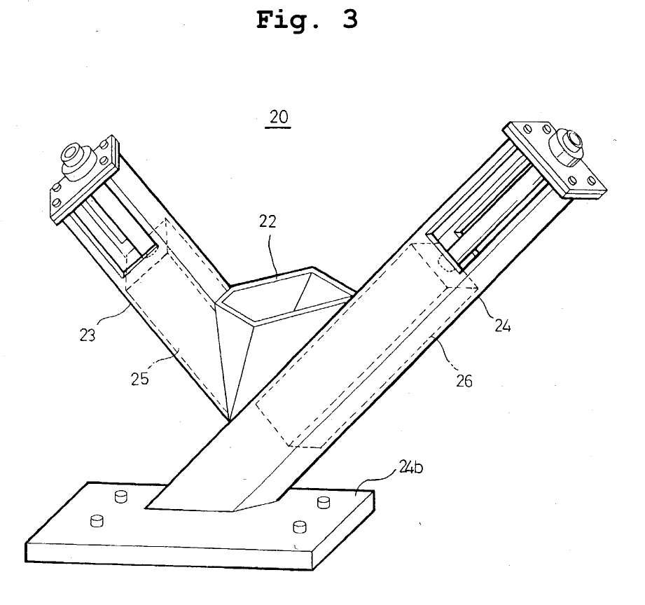

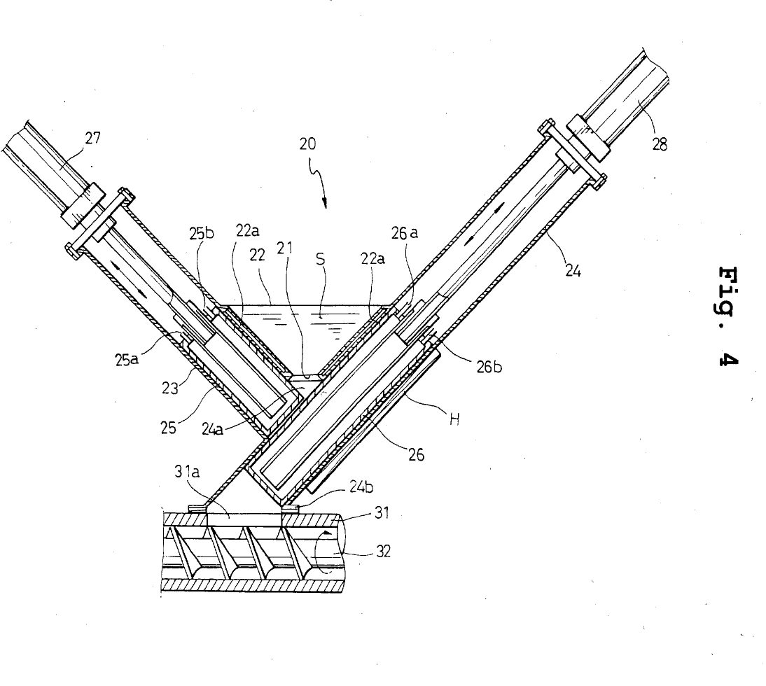

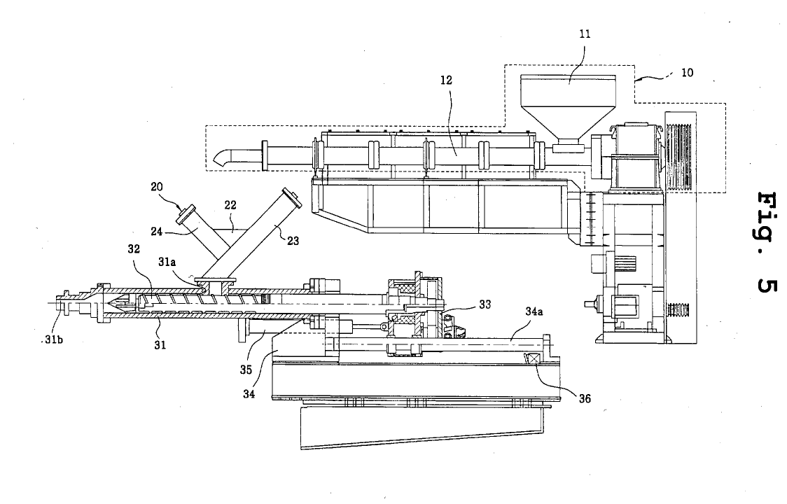

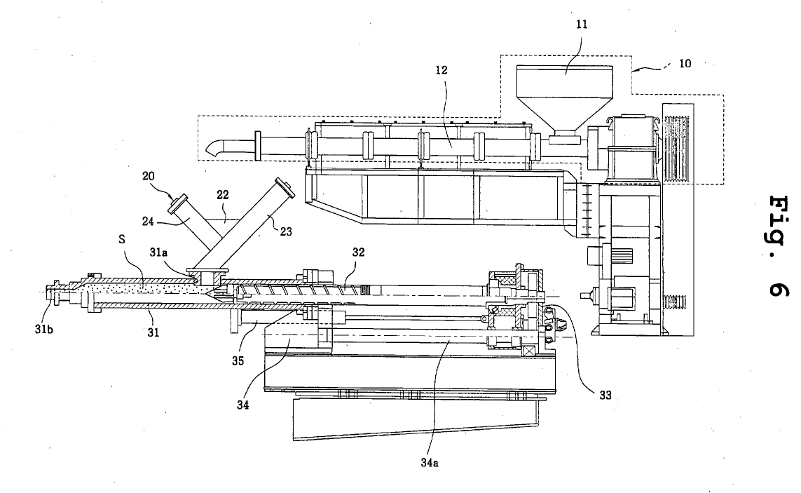

FIG. 1 is a front view of an apparatus for feeding soft reclaimed plastic to an injection molding machine according to an embodiment of the present invention. FIG. 2 is a plan view of first and second feeding units used for storing and feeding the soft reclaimed plastic in the plastic feeding apparatus. FIG. 3 is a perspective view of a hopper included in the first feeding unit of the plastic feeding apparatus. FIG. 4 is a sectional view of the hopper of FIG. 3. FIGS. 5 and 6 are sectional views of the plastic feeding apparatus, in which FIG. 5 shows a state of storing soft reclaimed plastic, and FIG. 6 shows a state of discharging the soft reclaimed plastic.

As shown in the drawings, the apparatus for feeding reclaimed plastic to an injection molding machine according to the present invention includes a heating unit 10 having both a plastic intake port 11 and a melting furnace 12. The plastic intake port 11 supplies reclaimable waste plastic articles to the heating unit 10, and the melting furnace 12 heats and melts the plastic articles at a predetermined temperature to prepare soft reclaimed plastic. The plastic feeding apparatus further includes a first feeding unit 20 and a second feeding unit 30. The first feeding unit 20 receives the soft reclaimed plastic “S” fed from the melting furnace 12 of the heating unit 10. The second feeding unit 30 temporarily stores therein the soft reclaimed plastic “S” fed from the first feeding unit 20, and controllably feeds the soft reclaimed plastic “S” to the injection molding machine in accordance with a predetermined quantity of soft reclaimed plastic required by the molding machine.

The first feeding unit 20 includes a hopper 22 having a funnel-shaped chamber. The top of the hopper 22 is opened to receive the soft reclaimed plastic into the hopper 22, and the bottom of the hopper 22 is provided with a plastic feeding passage 21. First and second cylinders 23 and 24 are mounted along both sides of the hopper 22 to form a Y-shaped profile. First and second pistons 25 and 26 are installed in the first and second cylinders 23 and 24 to discharge the soft reclaimed plastic. The first feeding unit 20 also includes first and second hydraulic cylinder actuators 27 and 28 connected to the first and second pistons 25 and 26.

A plastic inlet passage 24a is formed on the first and second cylinders 23 and 24 to communicate with the plastic feeding passage 21 of the hopper 22, and a flange 24b is formed at a lower end of the second cylinder 24.

A heater “H” is mounted to the external surface of either of the first and second cylinders 23 and 24. A cooling unit (not shown) may be installed in the first feeding unit, as desired.

The heater “H” heats the soft reclaimed plastic “S” to a desired temperature when the soft reclaimed plastic “S” is received into a cylinder having the heater “H”.

A water jacket 22a is formed on the internal surface of the hopper 22. The first and second pistons 25 and 26 are hollow pistons, with a water inlet hole 25a, 26a and a water outlet hole 25b, 26b being provided on each of the first and second pistons 25 and 26 to circulate cooling water through each of the first and second pistons 25 and 26. In the present invention, a water jacket (not shown) may be formed on the internal surface of each of the first and second cylinders 23 and 24.

The second feeding unit 30 includes a storage chamber part 31 having a longitudinal cylindrical shape. The storage chamber part 31 is provided with an inlet port 31a to receive the soft reclaimed plastic “S” discharged from the first feeding unit 20. An outlet port 31b is formed at a front end of the storage chamber part 31. A feed screw 32 is installed in the storage chamber part 31 to be rotated and linearly reciprocate along the storage chamber part 31. The second feeding unit 30 also has a hydraulic drive unit 33 connected to a rear end of the feed screw 32 to rotate the feed screw 32. A platform 34 guides a horizontal movement of both the hydraulic drive unit 33 and the feed screw 32. The second feeding unit 30 further includes a third hydraulic cylinder actuator 35 which is connected to the hydraulic drive unit 33 to horizontally move the hydraulic drive unit 33 in opposite directions, thus advancing and retracting the hydraulic drive unit 33 with the feed screw 32.

In the present invention, a hydraulic motor may be preferably used as the hydraulic drive unit 33 so as to rotate the feed screw.

The platform 34 comprises a plurality of guides 34a to guide the horizontal movement of the hydraulic drive unit 33 connected to the feed screw 32. A limit switch 36 is installed on the platform 34 to sense a retracted position of the hydraulic drive unit 33. The position of the limit switch 36 is determined in accordance with a retracted distance of the feed screw 32, and the retracted distance of the feed screw 32 is determined within a range in which the quantity of soft reclaimed plastic “S” charged in the storage chamber part 31 is controlled as desired.

The operational effect of the plastic feeding apparatus according to the present invention will be described herein below.

In an operation of the plastic feeding apparatus according to the present invention, reclaimable waste plastic articles are supplied to the heating unit 10 through the plastic intake port 11. In the heating unit 10, the waste plastic articles are fed to the melting furnace 12 so as to be heated and melted at a predetermined temperature, so that soft reclaimed plastic “S” is prepared. The soft reclaimed plastic “S” discharged from the melting furnace 12 is primarily stored in the hopper 22 of the first feeding unit 20.

The top of the hopper 22 is opened, so that gas and moisture generated from the soft reclaimed plastic “S” are naturally expelled from the hopper 22 to the atmosphere. It is thus possible to prevent generation of bubbles during an injection molding process of producing plastic products using the soft reclaimed plastic. Therefore, products having desired quality are produced.

When the soft reclaimed plastic is stored in the hopper 22, the water jacket 22a provided between the hopper 22, the first cylinder 23 and the second cylinder 24 prevents the soft reclaimed plastic “S” from being stuck to the internal surface of the hopper 22. The water jacket 22a also cools the soft reclaimed plastic to a predetermined temperature.

When it is desired to feed the soft reclaimed plastic “S” from the first feeding unit 20 to the second feeding unit 30, the first and second pistons 25 and 26, which are installed in the first and second cylinders 23 and 24 mounted along both sides of the hopper 22 to form the Y-shaped profile, are selectively moved by actuating rods of the first and second hydraulic cylinder actuators 27 and 28, thus feeding the soft reclaimed plastic “S” from the hopper 22 into the storage chamber part 31 of the second feeding unit 30.

The soft reclaimed plastic is fed from the first feeding unit 20 to the second feeding unit 30, as follows. When the first piston 25 is moved to its retracted position inside the first cylinder 23, the soft reclaimed plastic “S” is fed from the hopper 22 into the first cylinder 23 through the plastic feeding passage 21 provided at the bottom of the hopper 22. In such a case, the piston 26 of the second cylinder 24 is not actuated, so the piston 26 does not move in the second cylinder 24. However, when the retracted first piston 25 is moved forward to its advanced position inside the first cylinder 23 by the first hydraulic cylinder actuator 27, the second piston 26 is moved to its retracted position inside the second cylinder 24 by the second hydraulic cylinder actuator 28.

Thereafter, the second piston 26 is moved forward to its advanced position inside the second cylinder 24 by the second hydraulic cylinder actuator 28, so that the soft reclaimed plastic “S” is fed from the first cylinder 23 into the storage chamber part 31 through the inlet port 31a of the chamber part 31.

That is, the soft reclaimed plastic “S” is fed from the first feeding unit 20 into the storage chamber part 31 of the second feeding unit 30 by means of an alternate reciprocating action of the first and second pistons 25 and 26 in the first and second cylinders 23 and 24 which are mounted along both sides of the hopper 22 to form a Y-shaped profile. In such a case, the soft reclaimed plastic “S” comes into contact with the first and second pistons 25 and 26. However, since the first and second pistons 25 and 26 are cooled by cooling water circulated through the water inlet holes 25a and 26a and the water outlet holes 25b and 26b, the soft reclaimed plastic “S” is smoothly fed into the storage chamber part 31 of the second feeding unit 30 without being stuck to the pistons 25 and 26.

Either of the first and second cylinders 23 and 24 is provided on the external surface thereof with a heater “H”, so that the soft reclaimed plastic “S” is heated to a desired temperature by the heater “H” when the soft reclaimed plastic “S” is received into the cylinder having the heater “H”. The soft reclaimed plastic “S” is thus more smoothly discharged from the first feeding unit 20.

In addition, a cooling unit (not shown) may be installed in the first feeding unit 20 so as to cool the soft reclaimed plastic “S” when the temperature of the soft reclaimed plastic “S” in the first feeding unit 20 is excessively high.

When the soft reclaimed plastic “S” is fed from the first feeding unit 20 into the storage chamber part 31 of the second feeding unit 30, the soft reclaimed plastic “S” is introduced to an area around the feed screw 32 inside the storage chamber part 31. In such a case, the feed screw 32 is gradually moved backward in accordance with an increase in the quantity of the soft reclaimed plastic “S” flowing into the storage chamber part 31. During the backward movement of the feed screw 32, the hydraulic drive unit 33 connected to the rear end of the feed screw 32 rotates the feed screw 32. Therefore, the soft reclaimed plastic “S” is collected in the front portion inside the storage chamber part 31.

As the soft reclaimed plastic “S” is continuously fed into the storage chamber part 31, the feed screw 32 is horizontally moved backward to reach a retracted position thereof, as shown in FIG. 6. In such a case, the hydraulic drive unit 33 is also moved in the same direction along with the feed screw 32, and the horizontal backward movement of the hydraulic drive unit 33 and the feed screw 32 is guided by the platform 34 which is installed on a support base.

During the backward movement of the hydraulic drive unit 33 and the feed screw 32, the hydraulic drive unit 33 comes into contact with the limit switch 36 of the platform 34, so that the limited switch 36 is turned on and outputs a signal. In accordance with the signal outputted from the limit switch 36, the third hydraulic cylinder actuator 35 connected to the hydraulic drive unit 33 horizontally moves the hydraulic drive unit 33 forward, so that the hydraulic drive unit 33 and the feed screw 32 are moved forward.

Therefore, it is possible to control the quantity of the soft reclaimed plastic “S” stored in the storage chamber part 31 by controlling the position of the limit switch 36 on the platform 34. When a predetermined quantity of soft reclaimed plastic “S” is contained in the storage chamber part 31, the third hydraulic cylinder actuator 35 horizontally moves the hydraulic drive unit 33 forward. The feed screw 32 is thus moved forward in the storage chamber part 31, and feeds the predetermined quantity of soft reclaimed plastic “S” to the injection molding machine through the outlet port 31b formed at the front end of the storage chamber part 31. In such a case, the feed screw 32 which moves forward in the storage chamber part 31 functions as a piston to feed the soft reclaimed plastic “S” to the injection molding machine.

The soft reclaimed plastic “S” discharged from the storage chamber part 31 through the outlet port 31b by the feed screw 32 flows into the cavity of a mold of the injection molding machine, and is molded as a desired product. The plastic feeding apparatus of the present invention steadily feeds a predetermined quantity of soft reclaimed plastic to the injection molding machine by the feed screw as described above, thus improving productivity and quality of injection-molded plastic products. The plastic feeding apparatus also allows production of uniform quality products.

As described above, the present invention provides an apparatus for feeding soft reclaimed plastic to an injection molding machine. In the apparatus of the present invention, soft reclaimed plastic is primarily fed smoothly and steadily from a hopper of a first feeding unit into a storage chamber part of a second feeding unit through cylinders of the first feeding unit in accordance with a piston action inside the cylinders arranged in a Y-shaped profile, and is secondarily fed from the storage chamber part to the injection molding machine. When the apparatus of the present invention is used in an injection molding process, it is possible to produce large-sized products requiring a large quantity of soft reclaimed plastic. The apparatus also improves workability and productivity while producing injection-molded products. The hopper of the first feeding unit is opened at the top thereof, and is provided with a cooling water jacket, thus improving quality of injection-molded products and allowing production of uniform quality products.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for feeding reclaimed plastic to an injection molding machine, comprising a heating unit having both a plastic intake port to supply plastic articles to be reclaimed to the heating unit, and a melting furnace to heat and melt the plastic articles at a predetermined temperature to prepare soft reclaimed plastic, further comprising;
a first feeding unit receiving the soft reclaimed plastic fed from the melting furnace of the heating unit; and
a second feeding unit temporarily storing therein the soft reclaimed plastic fed from the first feeding unit, and controllably feeding the soft reclaimed plastic to the injection molding machine in accordance with a predetermined quantity of soft reclaimed plastic required by said molding machine.

2. The apparatus according to claim 1, wherein said first feeding unit comprises:
a hopper having a funnel-shaped chamber, with a top of said hopper being opened to receive the soft reclaimed plastic into the hopper and a plastic feeding passage being formed at a bottom of said hopper;
first and second cylinders mounted along both sides of said hopper to form a Y-shaped profile;
first and second pistons installed in said first and second cylinders to discharge the soft reclaimed plastic; and
first and second hydraulic cylinder actuators connected to the first and second pistons.

3. The apparatus according to claim 2, wherein a plastic inlet passage is formed on said first and second cylinders to communicate with said plastic feeding passage of the hopper, and a flange is formed at an end of said second cylinder.

4. The apparatus according to claim 2, wherein a heater is mounted to an external surface of either of said first and second cylinders, and a water jacket is formed on an internal surface of said hopper.

5. The apparatus according to claim 2, wherein said first and second pistons are hollow pistons, with a water inlet hole and a water outlet hole being provided on each of said first and second pistons to circulate cooling water through each of said first and second pistons.

6. The apparatus according to claim 1, wherein said second feeding unit comprises:
a storage chamber part having a longitudinal cylindrical shape and provided with an inlet port to receive the soft reclaimed plastic discharged from the first feeding unit, and an outlet port formed at an end of said storage chamber part;
a feed screw installed in said storage chamber part to be rotated and reciprocated along the storage chamber part;
a hydraulic drive unit connected to an end of said feed screw to rotate the feed screw;
a platform to guide a horizontal movement of both the hydraulic drive unit and the feed screw; and
a hydraulic cylinder actuator connected to the hydraulic drive unit to horizontally move said hydraulic drive unit in opposite directions, thus advancing and retracting the hydraulic drive unit.

7. The apparatus according to claim 6, wherein said platform comprises a plurality of guides to guide the horizontal movement of said hydraulic drive unit, with a limit switch being installed on said platform to sense a retracted position of said hydraulic drive unit.
